(19) United States
(12) Patent Application Publication
(10) Pub. No.: US 2013/0260258 A1
(43) Pub. Date: Oct. 3, 2013

(54) ELECTRODE BODY AND ALL SOLID STATE BATTERY

(71) Applicants: Yasushi Tsuchida, Susono-shi (JP); Hiroki Awano, Susono-shi (JP)

(72) Inventors: Yasushi Tsuchida, Susono-shi (JP); Hiroki Awano, Susono-shi (JP)

(73) Assignee: TOYOTA JIDOSHA KABUSHIKI KAISHA, Toyota-shi, Aichi (JP)

(21) Appl. No.: 13/991,774

(22) PCT Filed: Dec. 10, 2010
(86) PCT No.: PCT/JP2010/072225

§ 371 Date: Jun. 5, 2013

(51) Int. Cl. H01M 10/0562

(52) U.S. Cl. CPC H01M 10/0562
USPC 429/304; 429/209

(57) ABSTRACT

The problem of the present invention is to provide an electrode body excellent in cycling characteristics, which restrains interface resistance from increasing with time. The present invention solves the above-mentioned problem by providing an electrode body comprising: an electrode active material comprising an oxide, a first solid electrolyte material comprising a sulfide, and a second solid electrolyte material disposed at an interface between the electrode active material and the first solid electrolyte material, wherein a difference between electronegativity of a skeleton element in the second solid electrolyte material and electronegativity of an oxygen element is smaller than a difference between electronegativity of a skeleton element bonded to a sulfur element in the first solid electrolyte material and electronegativity of an oxygen element.

### TECHNICAL FIELD

The present invention relates to an electrode body excellent in cycling characteristics, which restrains interface resistance from increasing with time.

### BACKGROUND ART

In accordance with a rapid spread of information relevant apparatuses and communication apparatuses such as a personal computer, a video camera and a portable telephone in recent years, the development of a battery to be utilized as a power source thereof has been emphasized. The development of a high-output and high-capacity battery for an electric automobile or a hybrid automobile has been advanced also in the automobile industry. A lithium battery has been presently noticed from the viewpoint of a high energy density among various kinds of batteries.

Liquid electrolyte containing a flammable organic solvent is used for a presently commercialized lithium battery, so that the installation of a safety device for restraining temperature rise during a short circuit and the improvement in structure and material for preventing the short circuit are necessary therefor. On the contrary, a lithium battery all-solidified by replacing the liquid electrolyte with a solid electrolyte layer is conceived to intend the simplification of the safety device and be excellent in production cost and productivity for the reason that the flammable organic solvent is not used in the battery.

The intention of improving performance of an all solid state battery while noticing the interface between an electrode active material and a solid electrolyte material has been conventionally attempted in the field of such an all solid state battery. For example, in Non Patent Literature 1, a material such that the surface of LiCoO₂ (cathode active material) is coated with NiNbO₃ is disclosed. This technique intends to achieve higher output of a battery by coating the surface of LiCoO₂ with LiNbO₃ to decrease the interface resistance between LiCoO₂ and a solid electrolyte material. However, the coating the surface of LiCoO₂ with LiNbO₃ allows the interface resistance between LiCoO₂ and a solid electrolyte material to be decreased at the initial stage; yet, the problem is that the interface resistance increases with time. Then, for example, in Patent Literature 1, an all solid state battery, in which a cathode active material whose surface is coated with a reacting inhibition portion including a polyanion structure-containing compound is used, is disclosed. This intends to achieve higher durability of a battery by coating the surface of the cathode active material with the compound having a polyanion structure high in electrochemical stability to restrain the interface resistance between the cathode active material and a solid electrolyte material from increasing with time.

### CITATION LIST

### Patent Literature

Patent Literature 1: Japanese Patent Application Publication (JP-A) No. 2010-135090

### Non Patent Literature

Non Patent Literature 1: Narumi Ohta et al., “LiNbO₃-coated LiCoO₂ as cathode material for all solid-state lithium secondary batteries”, Electrochemistry Communications 9 (2007) 1486-1490

### SUMMARY OF INVENTION

### Technical Problem

The further restraint of an increase with time in interface resistance between an electrode active material and a solid electrolyte material and the further improvement of cycling characteristics have been demanded in an all solid state battery. The present invention has been made in view of the above-mentioned actual circumstances, and the main object thereof is to provide an electrode body excellent in cycling characteristics, which restrains interface resistance from increasing with time.

### Solution to Problem

In order to solve the above-mentioned problems, the present invention provides an electrode body comprising: an electrode active material comprising an oxide, a first solid electrolyte material disposed at an interface between the above-mentioned electrode active material and the above-mentioned first solid electrolyte material, wherein a different between electronegativity of a skeleton element in the above-mentioned second solid electrolyte material and electronegativity of an oxygen element is smaller than a difference between electronegativity of a skeleton element bonded to a sulfur element in the above-mentioned first solid electrolyte material and electronegativity of the oxygen element.

According to the present invention, a difference in electronegativity between a skeleton element in the second solid electrolyte material, disposed at an interface between the electrode active material and the first solid electrolyte material, and an oxygen element is so smaller than a difference in electronegativity between a skeleton element bonded to a sulfur element in the first solid electrolyte material and an oxygen element that oxygen is easily bonded to a skeleton element in the second solid electrolyte material and the oxidation of the first solid electrolyte material may be restrained. Thus, an electrode body excellent in cycling characteristics, which restrains interface resistance between the electrode active material and the first solid electrolyte material from increasing with time, may be obtained.

In the above-mentioned invention, a skeleton element bonded to a sulfur element in the above-mentioned first solid electrolyte material is preferably at least one kind selected from the group consisting of P, Si, B and Ge. The reason therefor is to allow the first solid electrolyte material with favorable ion conductivity.

In the above-mentioned invention, a skeleton element in the above-mentioned second solid electrolyte material is preferably at least one kind selected from the group consisting of W, Au, Pt, Ru and Os.

In the above-mentioned invention, the above-mentioned second solid electrolyte material is preferably disposed so as to coat a surface of the above-mentioned electrode active material. The reason therefor is that the electrode active material is so hard as compared with the first solid electrolyte material that the coated second solid electrolyte material is peeled off with difficulty.

In the above-mentioned invention, the above-mentioned electrode active material is preferably a cathode active material. The reason therefor is that the electrode body of the present invention may be regarded as a cathode body with high energy density by having an oxide cathode active material.

Also, the present invention provides an all solid state battery comprising: a cathode active material layer containing a cathode active material, an anode active material layer containing an anode active material, and a solid electrolyte layer formed between the above-mentioned cathode active material layer and the above-mentioned anode active material layer, wherein at least one electrode active material of the above-mentioned cathode active material and the above-mentioned anode active material includes an oxide, a second solid electrolyte material is disposed at an interface between the above-mentioned electrode active material comprising an oxide and a first solid electrolyte material comprising a sulfide, and a difference between electronegativity of a skeleton element in the above-mentioned second solid electrolyte material and electronegativity of an oxygen element is smaller than a difference between electronegativity of a skeleton element bonded to a sulfur element is the above-mentioned first solid electrolyte material and electronegativity of the oxygen element.

According to the present invention, a difference in electronegativity between a skeleton element in the second solid electrolyte material, disposed at an interface between the electrode active material and the first solid electrolyte material, and an oxygen element is so smaller than a difference in electronegativity between a skeleton element bonded to a sulfur element in the first solid electrolyte material and an oxygen element that oxygen is easily bonded to a skeleton element in the second solid electrolyte material and the oxidation of the first solid electrolyte material may be restrained. Thus, an all solid state battery excellent in cycling characteristics, which restrains interface resistance between the electrode active material and the first solid electrolyte material from increasing with time, may be obtained.

In the above-mentioned invention, the above-mentioned cathode active material layer preferably contains the above-mentioned first solid electrolyte material. The reason therefor is to allow ion conductivity of the cathode active material layer to be improved.

In the above-mentioned invention, the above-mentioned solid electrolyte layer preferably contains the above-mentioned first solid electrolyte material. The reason therefor is to allow the all solid state battery excellent in ion conductivity.

In the above-mentioned invention, the above-mentioned second solid electrolyte material is preferably disposed so as to coat a surface of the above-mentioned electrode active material. The reason therefor is that the electrode active material is so hard as compared with the first solid electrolyte material that the coated second solid electrolyte material is peeled off with difficulty.

In the above-mentioned invention, a skeleton element bonded to a sulfur element in the above-mentioned first solid electrolyte material is preferably at least one kind selected from the group consisting of P, Si, B and Ge. The reason therefor is to allow the first solid electrolyte material with favorable ion conductivity.

In the above-mentioned invention, a skeleton element in the above-mentioned second solid electrolyte material is preferably at least one kind selected from the group consisting of W, Au, Pt, Ru and Os.

### Advantageous Effects of Invention

The present invention produces the effect such as to allow an electrode body excellent in cycling characteristics, which restrains interface resistance from increasing with time.

### BRIEF DESCRIPTION OF DRAWINGS

FIG. 1 is a schematic cross-sectional view showing an example of an electrode body of the present invention.

FIGS. 2A to 2D are an explanatory view explaining an example of a form of a second solid electrolyte material in an electrode body of the present invention.

FIG. 3 is a schematic cross-sectional view showing an example of a power generating element of an all solid state battery of the present invention.

FIGS. 4A to 4D are an explanatory view explaining an example of a form of a second solid electrolyte material in an all solid state battery of the present invention.

FIGS. 5A to 5D are an explanatory view explaining another example of a form of a second solid electrolyte material in an all solid state battery of the present invention.

FIG. 6 is a graph showing a result of measuring interface resistance increasing rate of an all solid state battery obtained in each of Example 1 and Comparative Examples 1 and 2.

### DESCRIPTION OF EMBODIMENTS

An electrode body and an all solid state battery of the present invention are hereinafter described in detail.

A. Electrode Body

First, an electrode body of the present invention is described. The electrode body of the present invention is an electrode body comprising: an electrode active material comprising an oxide, a first solid electrolyte material comprising a sulfide, and a second solid electrolyte material disposed at an interface between the above-mentioned electrode active material and the above-mentioned first solid electrolyte material, wherein a difference between electronegativity of a skeleton element in the above-mentioned second solid electrolyte material and electronegativity of an oxygen element is smaller than a difference between electronegativity of a skeleton element bonded to a sulfur element in the above-mentioned first solid electrolyte material and electronegativity of the oxygen element.

According to the present invention, a difference in electronegativity between a skeleton element in the second solid electrolyte material, disposed at an interface between the electrode active material and the first solid electrolyte material, and an oxygen element is so smaller than a difference in electronegativity between a skeleton element bonded to a sulfur element in the first solid electrolyte material and an oxygen element that oxygen is easily bonded to a skeleton element in the second solid electrolyte material and the oxidation of the first solid electrolyte material may be restrained. Thus, an electrode body excellent in cycling characteristics, which restrains interface resistance between the electrode active material and the first solid electrolyte material from increasing with time, may be obtained.

In electronegativity of Pauling, electronegativity of an oxygen element is 3.44. Generally, it is known that an element having electronegativity closer to electronegativity of an oxygen element (3.44) is oxidized more easily and is bonded to oxygen more easily. In the present invention, a skeleton element in the second solid electrolyte material is smaller in a difference of electronegativity from an oxygen element than a skeleton element bonded to a sulfur element in the first solid electrolyte material; that is, a skeleton element in the second solid electrolyte material is bonded to oxygen more easily than a skeleton element bonded to a sulfur element in the first solid electrolyte material. Accordingly, bond stability between the second solid electrolyte material and oxygen becomes so larger than bond stability between the first solid electrolyte material and oxygen that free energy ΔG in an oxidation reaction of the first soli electrolyte material becomes positive and the oxidation reaction of the first solid electrolyte material may be restrained from proceeding.

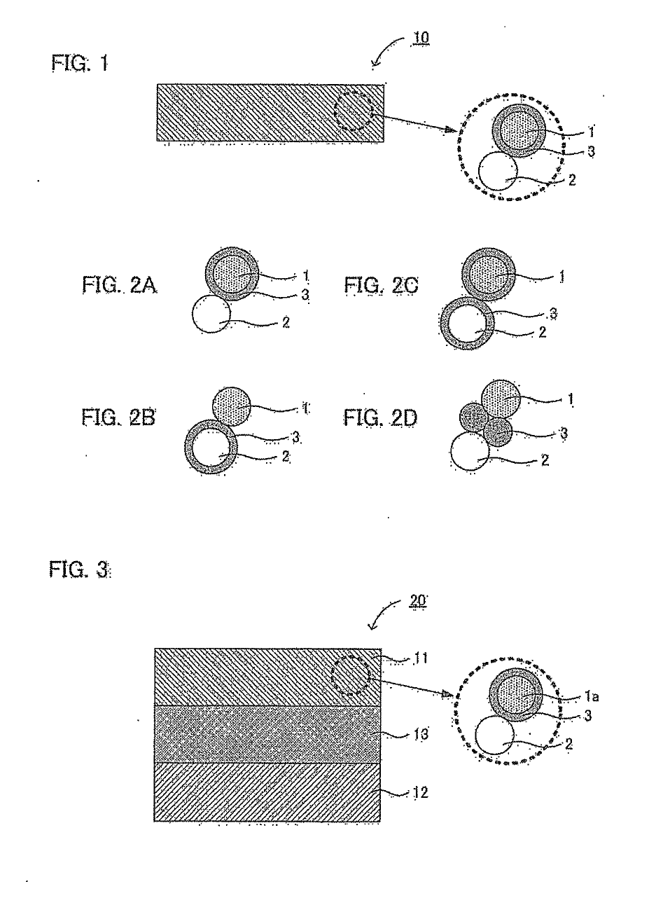

FIG. 1 is a schematic cross-sectional view showing an example of the electrode body of the present invention. An electrode body 10 shown in FIG. 1 comprises an electrode active material 1 comprising an oxide, a first solid electrolyte material 2 comprising a sulfide, and a second solid electrolyte material 3 disposed at an interface between the electrode active material 1 and the first solid electrolyte material 2.

The electrode boy of the present invention is hereinafter described in each constitution.

1. First Solid Electrolyte Material

First, the first solid electrolyte material in the present invention is described. The first solid electrolyte material in the present invention is a sulfide solid electrolyte material comprising a sulfide. The sulfide solid electrolyte material used for the present invention is not particularly limited if the material contains sulfur (S) and has ion conductivity. In the case where the electrode body of the present invention is used for an all solid lithium battery, examples of the sulfide solid electrolyte material used for the present invention include a sulfide solid electrolyte material obtained by using a raw material composition containing Li₂S and a sulfide of an element of the thirteenth family to the fifteenth family. Examples of a method for synthesizing the sulfide solid electrolyte material by using such a raw material composition include an amorphizing method. Examples of the amorphizing method include a mechanical milling method and a melt extraction method.

Examples of an element of the above-mentioned thirteenth family to fifteenth family include B, Al, Si, Ge, P, As and Sb. Also, specific examples of a sulfide of an element of the thirteenth family to the fifteenth family include B₂S₃, Al₂S₃, SiS₂, GeS₂, P₂S₃, P₂S₅, As₂S₃ and Sb₂S₃. In particular, in the present invention, the sulfide solid electrolyte material obtained by using a raw material composition containing Li₂S and a sulfide of an element of the thirteenth family to the fifteenth family is preferably an Li₂S—P₂S₅ material, an Li₂S—SiS₂ material, an Li₂S—B₂S₃ material and an Li₂S—GeS₂ material, and more preferably an Li₂S—P₂S₅ material. The reason therefor is to be excellent in Li ion conductivity. That is to say, in the present invention, a skeleton element bonded to a sulfur element in the above-mentioned first solid electrolyte material is preferably at least one kind selected from the group consisting of P, Si, B and Ge, and more preferably P. The reason therefor is to allow the first solid electrolyte material excellent in ion conductivity. Here, “skeleton element” signifies an element as a cation among elements except an element as a conductive ion in constituent elements of the solid electrolyte material. For example, in the case where the solid electrolyte material is the sulfide solid electrolyte material including a Li₂S—P₂S₅ material, the constituent elements are Li, P and S, the element as a conductive ion is Li, and the skeleton element is P.

Also, in the present invention, the first solid electrolyte material preferably has cross-linking sulfur. The reason therefor is that the sulfide solid electrolyte material having cross-linking sulfur is so high in ion conductivity as to allow ion conductivity of the electrode body of the present invention to be improved. Examples of the first solid electrolyte material having cross-linking sulfur include Li₇P₃S₁₁, 0.6Li₂S-0.4SiS₂ and 0.6Li₂S-0.4GeS₂. Here, the above-mentioned Li₇P₃S₁₁ is the sulfide solid electrolyte material having a PS₃—S—PS₃ structure and a PS₄ structure, and the PS₃—S—PS₃ structure has cross-linking sulfur. Thus, in the present invention, the first solid electrolyte material preferably has the PS₃—S—PS₃ structure. The reason therefor is to allow the effect of the present invention to be sufficiently produced.

Also, in the case where the first solid electrolyte material is the sulfide solid electrolyte material not having cross-linking sulfur, specific examples thereof include 0.8Li₂S-0.2P₂S₅ and Li_{3.25}Ge_{0.25}P_{0.75}S₄.

Also, the first solid electrolyte material in the present invention may be sulfide glass or crystallized sulfide glass obtained by heat-treating the sulfide glass. Sulfide glass may be obtained by the above-mentioned amorphizing method, for example. On the other hand, crystallized sulfide glass may be obtained by heat-treating sulfide glass, for example.

Examples of the shape of the first solid electrolyte material include a particulate shape, preferably a perfectly spherical shape or an elliptically spherical shape, above all. Also, in the case where the first solid electrolyte material is in a particular shape, the average particle diameter thereof is, for example, preferably within a range of 0.1 μm to 50 μm. Also, the content of the first solid electrolyte material in the electrode body of the present invention is, for example, preferably within a range of 1% by mass to 50% by mass, and more preferably within a range of 3% by mass to 30% by mass.

2. Second Solid Electrolyte Material

Next, the second solid electrolyte material in the present invention is described. The second solid electrolyte material in the present invention is disposed at an interface between the electrode active material comprising an oxide and the first solid electrolyte material comprising a sulfide. The second solid electrolyte material has the function of restraining a reaction between the electrode active material and the first slid electrolyte material, which is produced during the use of a battery. In the present invention, a difference between electronegativity of a skeleton element in the second solid electrolyte material and electronegativity of an oxygen element is so smaller than a difference between electronegativity of a skeleton element bonded to a sulfur element in the first soli electrolyte material and electronegativity of the oxygen element that oxygen is easily bonded to a skeleton element in the second solid electrolyte material, the oxidation of the first solid electrolyte material may be restrained, and interface resistance between the electrode active material and the first solid electrolyte material may be restrained from increasing with time.

The second solid electrolyte material in the present invention is not particularly limited if the material has ion conductivity and contains a skeleton element, which is smaller in a difference of electronegativity from an oxygen element than a skeleton element bonded to a sulfur element in the first solid electrolyte material; examples thereof include an oxide solid electrolyte material. Incidentally, skeleton element is as described above. Also, ordinarily, a skeleton element in the second solid electrolyte material is bonded to oxygen. This oxygen may be previously contained in the second solid electrolyte material, or taken into the second solid electrolyte material from the outside.

In the case where the electrode body of the present invention is used for an all solid lithium battery, the oxide solid electrolyte material used for the present invention contains Li as a conductive ion, oxygen (O), and an element, which is smaller in a difference of electronegativity from an oxygen element than a skeleton element bonded to a sulfur element in the first solid electrolyte material. Here, in the case where a skeleton element bonded to a sulfur element in the first solid electrolyte material is P, electronegativity of P element is 2.19 in electronegativity of Pauling therefore, examples of the element, which is smaller in a difference of electronegativity from an oxygen element (electronegativity: 3.44) than a skeleton element bonded to a sulfur element in the first solid electrolyte material, including W (electronegativity: 2.36), Ru (electronegativity: 2.2), Os (electronegativity: 2.2), Rh (electronegativity: 2.28), Ir (electronegativity: 2.2), Pd (electronegativity: 2.2), Pt (electronegativity: 2.28), Au (electronegativity: 2.54), C (electronegativity: 2.55), Pb (electronegativity: 2.33), N (electronegativity: 3.04), S (electronegativity: 2.58) and Se (electronegativity: 2.55). Above all, in the present invention, a skeleton element in the above-mentioned second solid electrolyte material is preferably at least one kind selected from the group consisting of W, Au, Pt, Ru and Os, and more preferably W. The reason therefor is to be so large in valence number difference from an element of the electrode active material as to react with the electrode active material with difficulty. A small valence number difference from an element of the electrode active material brings a possibility of causing solid solution. Specific examples of such a second solid electrolyte material include Li₂WO₄, Li₆WO₆, Li₂RuO₂, Li₃RuO₃, Li₄Ru₂O₇, Li₂RuO₄, and LiRuO₄.

As shown in FIGS. 2A to 2D, examples of a form of the present solid electrolyte material in the electrode body of the present invention include a form such that the second solid electrolyte material 3 is disposed so as to coat a surface of the electrode active material 1 (FIG. 2A), a form such that the second solid electrolyte material 3 is disposed so as to coat a surface of the first solid electrolyte material 2 (FIG. 2B), and a form such that the second solid electrolyte material 3 is disposed so as to coat a surface of the electrode active material 1 and the first solid electrolyte material 2 (FIG. 2C). Above all, in the present invention, the second solid electrolyte material is preferably disposed so as to coat a surface of the electrode active material. The reason therefor is that the electrode active material is so hard as compared with the first solid electrolyte material that the coated second solid electrolyte material is peeled off with difficulty.

Incidentally, simple mixing of the electrode active material, the first solid electrolyte material and the second solid electrolyte material allows the second solid electrolyte material 3 to be disposed at an interface between the electrode active material 1 and the first solid electrolyte material 2, as shown in FIG. 2D. This case has the advantage that the production process of the electrode body is simplified through the effect of restraining interface resistance from increasing with time is somewhat deteriorated.

Also, the thickness of the second solid electrolyte material for coating a surface of the electrode active material or the first solid electrolyte material is preferably a thickness such that these materials do not react; for example, preferably within a range of 1 nm to 500 nm, and more preferably within a range of 2 nm to 100 nm. The reason therefor is that too small thickness of the second solid electrolyte material brings a possibility that the electrode active material and the first solid electrolyte material react, while too large thickness of the second solid electrolyte material brings a possibility that ion conductivity deteriorates. Also, the second solid electrolyte material preferably coats more areas of the electrode active material, and preferably coats the whole surface of the electrode active material. The reason therefor is to allow interface resistance to be effectively restrained from increasing with time. Specifically, the coverage factor of the second solid electrolyte material for coating a surface of the electrode active material is, for example, preferably 20% or more, and preferably 50% or more.

A method for disposing the second solid electrolyte material in the present invention is preferably selected properly in accordance with the above-mentioned form of the second solid electrolyte material. For example, in the case of disposing the second slid electrolyte material so as to coat a surface of the electrode active material, examples of a method for coating with the second solid electrolyte material include a tumbling flow coating method (a sol-gel method), a mechano-fusion method, a CVD method and a PVD method.

The content of the second solid electrolyte material in the electrode body of the present invention is, for example, preferably within a range of 0.1% by mass to 10% by mass, and more preferably within a range of 0.5% by mass to 5% by mass. Also, the ratio (mass ratio) of the second solid electrolyte material to the first solid electrolyte material is, for example, preferably within a range of 0.3% to 30%, and more preferably within a range of 1.5% to 15%.

3. Electrode Active Material

Next, the electrode active material in the present invention is described. The electrode active material in the present invention comprises an oxide and varies with kinds of a conductive ion of an all solid state battery for which the intended electrode body is used. For example, in the case where the electrode body of the present invention is used for an all solid lithium secondary battery, the electrode active material absorbs and releases a lithium ion. Also, the electrode active material in the present invention may be a cathode active material or an anode active material.

The cathode active material used for the present invention is not particularly limited if the material comprises an oxide. In the case where the electrode body of the present invention is used for an all solid lithium battery, examples of the cathode active material to be used include an oxide cathode active material represented by a general formula LiₓM_{y}O_{z} (M is a transition metallic element, x=0.02 to 2.2, y=1 to 2 and z=1.4 to 4). In the above-mentioned general formula, M is preferably at least one kind selected from the group consisting of Co, Mn, Ni, V and Fe, and more preferably at least one kind selected from the group consisting of Co, Ni and Mn. Specific examples of such an oxide cathode active material include rock salt bed type active materials such as LiCoO₂, LiMnO₂, LiNiO₂, LiVO₂ and LiNi_{1/3}Co_{1/3}Mn_{1/3}O₂, and spinel type active materials such as LiMn₂O₄ and Li(Ni_{0.5}Mn_{1.5})O₄. Also, examples of the cathode active material except the above-mentioned general formula of LiₓM_{y}O_{z}include olivine type active materials such as LiFePO₄ and LiMnPO₄. Also, Si-containing oxides such as Li₂FeSiO₄ and Li₂MnSiO₄ may be used as the cathode active material.

Examples of the shape of the cathode active material include a particulate shape, and preferably a perfectly spherical shape or an elliptically spherical shape, above all. Also, in the case where the cathode active material is in a particulate shape, the average particle diameter thereof is, for example, preferably within a range of 0.1 μm to 50 μm.

On the other hand, the anode active material used for the present invention is not particularly limited if the material comprises an oxide, but examples thereof include Nb₂O₅, Li₄Ti₅O₁₂ and SiO.

Examples of the shape of the anode active material include a particulate shape, and preferably a perfectly spherical shape on an elliptically spherical shape, above all. Also, in the case where the anode active material is in a particulate shape, the average particle diameter thereof is, for example, preferably within a range of 0.1 μm to 50 μm.

4. Electrode Body

The electrode body of the present invention may further comprise a conductive material. The addition of the conductive material allows electrical conductivity of the electrode body to be improved. Examples of the conductive material include acetylene black, Ketjen Black and carbon fiber. Also, the above-mentioned electrode body may further contain a binder. Examples of the binder include fluorine-containing binders such as PTFE and PVDF. The thickness of the electrode body of the present invention varies with factors such as uses of the electrode body and is preferably within a range of 0.1 μm to 1000 μm, for example.

Also, the electrode body of the present invention is preferably used as an electrode active material layer of an all solid state battery, for example. The reason therefor is that interface resistance between the electrode active material and the solid electrolyte material may be restrained from increasing with time and an all solid state battery excellent in cycling characteristics may be obtained.

A method for producing the electrode body of the present invention is not particularly limited if the method is a method such as to allow the above-mentioned electrode body. Examples thereof include a method such that a surface of the electrode active material is coated with the second solid electrolyte material to mix and press-mold the electrode active material, whose surface is coated with the second solid electrolyte material, and the first solid electrolyte material.

B. All Solid State Battery

Next, an all solid state battery of the present invention is described. The all solid state battery of the present invention comprises a cathode active material layer containing a cathode active material, an anode active material layer containing an anode active material, and a solid electrolyte layer formed between the above-mentioned cathode active material layer and the above-mentioned anode active material layer, wherein at least one electrode active material of the above-mentioned cathode active material and the above-mentioned anode active material comprises an oxide, a second solid electrolyte material is disposed at an interface between the above-mentioned electrode active material comprising an oxide an a first solid electrolyte material comprising a sulfide, and a difference between electronegativity of a skeleton element in the above-mentioned second solid electrolyte material and electronegativity of an oxygen element is smaller than a difference between electronegativity of a skeleton element bonded to a sulfur element in the above-mentioned first solid electrolyte material and electronegativity of the oxygen element.

According to the present invention, a difference in electronegativity between a skeleton element in the second solid electrolyte material, disposed at an interface between the electrode active material and the first solid electrolyte material, and an oxygen element is so smaller than a difference in electronegativity between a skeleton element bonded to a sulfur element in the first solid electrolyte material and an oxygen element that oxygen is easily bonded to a skeleton element in the second solid electrolyte material and the oxidation of the first solid electrolyte material may be restrained. Thus, an all solid state battery excellent in cycling characteristics, which restrains interface resistance between the electrode active material and the first solid electrolyte material from increasing with time, may be obtained.

FIG. 3 is a schematic cross-sectional view showing an example of a power generating element of the all solid state battery of the present invention. A power generating element 20 of the all solid state battery shown in FIG. 3 comprises a cathode active material layer 11, an anode active material layer 12, and a solid electrolyte layer 13 formed between the cathode active material layer 11 and the anode active material layer 12. In addition, the cathode active material layer 11 has a cathode active material 1a comprising an oxide, a first solid electrolyte material 2 comprising a sulfide, and a second solid electrolyte material 3 disposed at an interface between the cathode active material 1a and the first solid electrolyte material 2. In FIGS. 2A to 2D, the second solid electrolyte material 3 is disposed so as to coat a surface of the cathode active material 1a.

The all solid state battery of the present invention is hereinafter described in each constitution.

1. Cathode Active Material Layer

First, the cathode active material layer in the present invention is described. The cathode active material layer in the present invention is a layer containing at least the cathode active material, and may further contain at least one of a solid electrolyte material, a conductive material and a binder as required. In the present invention, the solid electrolyte material contained in the cathode active material layer is preferably the first solid electrolyte material. The reason therefor is to allow ion conductivity of the cathode active material layer to be improved. Also, in the present invention, in the case where the cathode active material layer contains both the cathode active material comprising an oxide and the first solid electrolyte material, the second solid electrolyte material is ordinarily disposed in the cathode active material layer.

Examples of the cathode active material used for the present invention include the cathode active material described in the above-mentioned “A. Electrode body”. Incidentally, S (sulfur) may be also used as the cathode active material. Also, in the case where the anode active material used for the present invention comprises an oxide, a cathode active material except the oxide cathode active material may be used as the cathode active material. The content of the cathode active material in the cathode active material layer is, for example, preferably within a range of 10% by mass to 99% by mass, and more preferably within a range of 20% by mass to 90% by mass.

In the present invention, the cathode active material layer preferably contains the first solid electrolyte material. The reason therefor is to allow ion conductivity of the cathode active material to be improved. Incidentally, the first solid electrolyte material used for the present invention is the same as the contents described in the above-mentioned “A. Electrode body”; therefore, the description herein is omitted. The content of the first solid electrolyte material in the cathode active material layer is, for example, preferably within a range of 1% by mass to 90% by mass, and more preferably within a range of 10% by mass to 80% by mass.

In the present invention, in the case where the cathode active material layer contains both the cathode active material comprising an oxide and the first solid electrolyte material, also the second solid electrolyte material is ordinarily contained in the cathode active material layer. The reason therefor is that the second solid electrolyte material needs to be disposed at an interface between the cathode active material comprising an oxide and the first solid electrolyte material. The second solid electrolyte material has the function of restraining a reaction between the cathode active material and the first solid electrolyte material, which is produced during the use of a battery. In the present invention, a difference between electronegativity of a skeleton element in the second solid electrolyte material and electronegativity of an oxygen element is so smaller than a difference between electronegativity of a skeleton element bonded to a sulfur element in the first solid electrolyte material and electronegativity of an oxygen element that oxygen is easily bonded to a skeleton element in the second solid electrolyte material, the oxidation of the first solid electrolyte material may be restrained, and interface resistance between the cathode active material and the first solid electrolyte material may be restrained from increasing with time. Incidentally, the second solid electrolyte material used for the present invention is the same as the contents described in the above-mentioned “A. Electrode body”; therefore, the description herein is omitted.

In the present invention, in the case where the cathode active material layer contains the cathode active material comprising an oxide and the first solid electrolyte material, the second solid electrolyte material is ordinarily disposed in the cathode active material layer. Examples of a form of the second solid electrolyte material in this case include a form such that the electrode active material 1 is the cathode active material in the above-mentioned FIGS. 2A to 2D. Above all, in the present invention, the second solid electrolyte material is preferably disposed so as to coat a surface of the cathode active material. The reason therefor is that the cathode active material is so hard as compared with the first solid electrolyte material that the coated second solid electrolyte material is peeled off with difficulty.

Incidentally, simple mixing of the cathode active material, the first solid electrolyte material and the second solid electrolyte material allows the second solid electrolyte material to be disposed at an interface between the cathode active material and the first solid electrolyte material, similarly to in the above-mentioned FIG. 2D. This case has the advantage that the production process of the cathode active material layer is simplified though the effect of restraining interface resistance from increasing with time is somewhat deteriorated.

Also, the thickness of the second solid electrolyte material for coating the cathode active material or the first solid electrolyte material is preferably a thickness such that these materials do not react; for example, preferably within a range of 1 nm to 500 nm, and more preferably within a range of 2 nm to 100 nm. The reason therefor is that too small thickness of the second solid electrolyte material brings a possibility that the cathode active material and the first solid electrolyte material react, while too large thickness of the second solid electrolyte material brings a possibility that ion conductivity deteriorates. Also, the second solid electrolyte material preferably coats more areas of the cathode active material, and preferably coats the whole surface of the cathode active material. The reason therefor is to allow interface resistance to be effectively restrained from increasing with time. Specifically, the coverage factor of the second solid electrolyte material for coating a surface of the cathode active material is, for example, preferably 20% or more, and preferably 50% or more.

Incidentally, a method for disposing the second solid electrolyte material in the present invention is the same as the method described in the above-mentioned “A. Electrode body”.

The cathode active material layer in the present invention may further contain a conductive material. The addition of the conductive material allows electrical conductivity of the cathode active material layer to be improved. Examples of the conductive material include acetylene black, Ketjen Black and carbon fiber. Also, the above-mentioned carbon active material layer may further contain a binder. Examples of the binder include fluorine-containing binders such as PTFE and PVDF. Also, the thickness of the cathode active material layer varies with kinds of an intended all solid state battery, and is preferably within a range of 0.1 μm to 1000 μm, for example.

2. Anode Active Material Layer

Next, the anode active material layer in the present invention is described. The anode active material layer in the present invention is a layer containing at least the anode active material, a conductive material and a binder as required. In the present invention, the solid electrolyte material contained in the anode active material layer is preferably the first solid electrolyte material. The reason therefor is to allow ion conductivity of the anode active material layer to be improved. Also, in the present invention, in the case where the anode active material layer contains both the anode active material comprising an oxide and the first solid electrolyte material, the second solid electrolyte material is ordinarily disposed in the anode active material layer.

Examples of the anode active material used for the present invention include the anode active material described in the above-mentioned ‘A. Electrode body’. Also, in the case where the cathode active material used for the present invention comprises an oxide, an anode active material except the oxide anode active material may be used as the anode active material; examples thereof include a metal active material and a carbon active material. Examples of the metal active material include In, Al, Si, and Sn. On the other hand, examples of the carbon active material include mesocarbon microbeads (MCMB), graphite such as high orientation property graphite (HOPG), and amorphous carbon such as hard carbon and soft carbon. Incidentally, SiC may be also used as the anode active material. Also, the content of the anode active material in the anode active material layer is, for example, preferably within a range of 10% by mass to 99% by mass, and more preferably within a range of 20% by mass to 90% by mass.

In the present invention, the anode active material layer preferably contains the first solid electrolyte material. The reason therefor is to allow ion conductivity of the anode active material layer to be improved. Incidentally, the first solid electrolyte material used for the present invention is the same as the contents described in the above-mentioned “A. Electrode body”; therefore, the description herein is omitted. The content of the first solid electrolyte material in the anode active material layer is, for example, preferably within a range of 1% by mass to 90% by mass, and more preferably within a range of 10% by mass to 80% by mass.

In the present invention, in the case where the anode active material layer contains both the anode active material comprising an oxide and the fist solid electrolyte material, also the second solid electrolyte material is ordinarily contained in the anode active material layer. The reason therefor is that the second solid electrolyte material needs to be disposed at an interface between the anode active material comprising an oxide and the first solid electrolyte material. The second solid electrolyte material has the function of restraining a reaction between the anode active material and the first solid electrolyte material, which is produced during the use of a battery. In the present invention, a difference between electronegativity of a skeleton element in the second solid electrolyte material and electronegativity of an oxygen element is so smaller than a difference between electronegativity of a skeleton element bonded to a sulfur element in the first solid electrolyte material and electronegativity of an oxygen element that oxygen is easily bonded to a skeleton element in the second solid electrolyte material, the oxidation of the first solid electrolyte material may be restrained, and interface resistance between the anode active material and the first solid electrolyte material may be restrained from increasing with time. Incidentally, the second solid electrolyte material used for the present invention is the same as the contents described in the above-mentioned “A. Electrode body”; therefore, the description herein is omitted. Also, a form of the second solid electrolyte material in the anode active material layer is the same as the above-mentioned case in the cathode active material layer.

Incidentally, the conductive material and the binder used for the anode active material layer are the same as the above-mentioned case in the cathode active material layer. Also, the thickness of the anode active material layer varies with kinds of an intended all solid state battery, and is preferably within a range of 0.1 μm to 1000 μm, for example.

3. Solid Electrolyte Layer

Next, the solid electrolyte layer in the present invention is described. The solid electrolyte layer in the present invention is a layer formed between the cathode active material layer and the anode active material layer, and a layer comprising a solid electrolyte material. As described above, in the case where at least one of the cathode active material layer and the anode active material layer contains the first solid electrolyte material, the solid electrolyte material used for the solid electrolyte layer is not particularly limited but may be the first solid electrolyte material or a solid electrolyte material except therefor. On the other hand, in the case where the cathode active material layer and the anode active material layer do not contain the first solid electrolyte material, the solid electrolyte layer ordinarily contains the first solid electrolyte material. In the present invention, both the cathode active material layer and the solid electrolyte layer preferably contain the first solid electrolyte material. The reason therefor is to allow the effect of the present invention to be sufficiently produced. Also, the solid electrolyte material used for the solid electrolyte layer is preferably only the first solid electrolyte material.

Incidentally, the first solid electrolyte material is the same as the contents described in the above-mentioned “A. Electrode body”. Also, the same material as a solid electrolyte material used for a general all solid state battery may be used for a solid electrolyte material except the first solid electrolyte material.

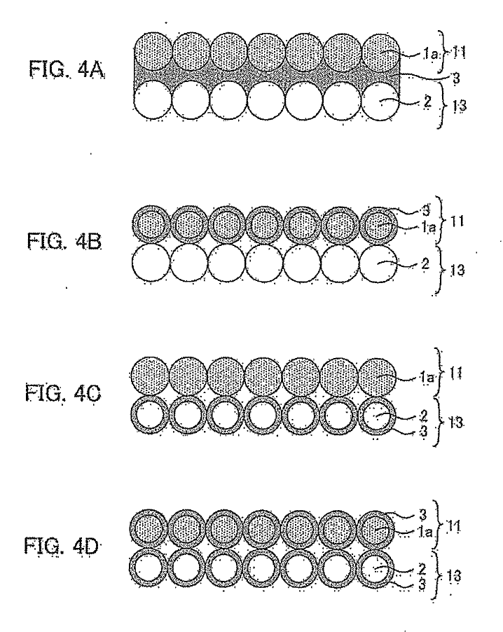

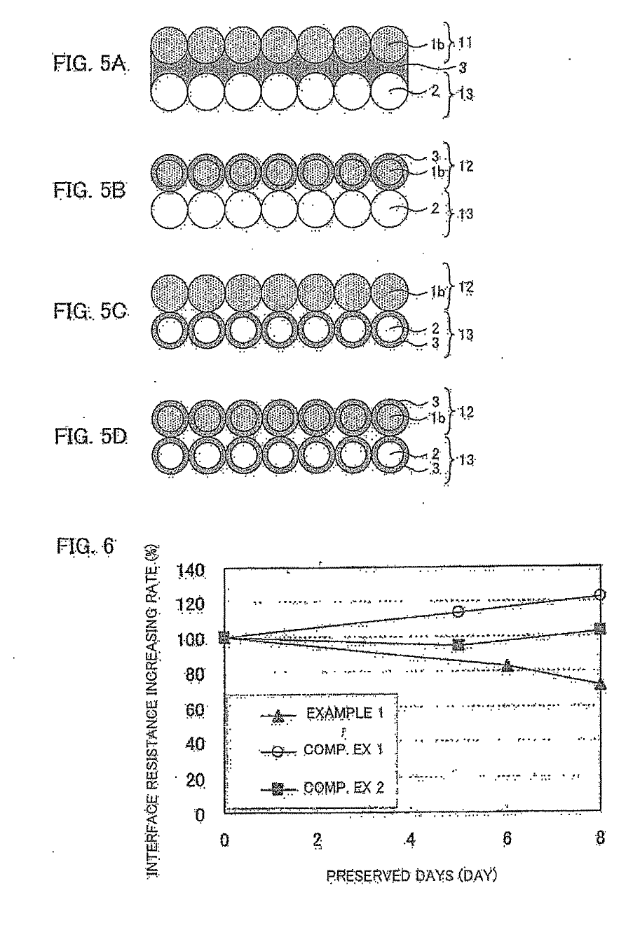

In the present invention, in the case where the solid electrolyte layer contains the first solid electrolyte material, the second solid electrolyte material, is ordinarily disposed in the cathode active material layer, in the solid electrolyte layer, in the anode active material layer, at an interface between the cathode active material layer and the solid electrolyte layer, or at an interface between the anode active material layer and the solid electrolyte layer. As shown in FIGS. 4 and 5, examples of a form of the second solid electrolyte material in this case include: a form such that the second solid electrolyte material 3 is disposed at an interface between the cathode active material layer 11 containing the cathode active material 1a and the solid electrolyte layer 13 containing the first solid electrolyte material 2 (FIG. 4A), a form such that the second solid electrolyte material 3 is disposed so as to coat a surface of the cathode active material 1a (FIG. 4B), a form such that the second solid electrolyte material 3 is disposed so as to coat a surface of the first solid electrolyte material 2 (FIG. 4C), a form such that the second solid electrolyte material 3 is disposed so as to coat a surface of the cathode active material 1a and the first solid electrolyte material 2 (FIG. 4D), a form such that the second solid electrolyte material 3 is disposed at an interface between an anode active material layer 12 containing an anode active material 1b and the solid electrolyte layer 13 containing the first solid electrolyte material 2 (FIG. 5A), a form such that the second solid electrolyte material 3 is disposed so as to coat a surface of the anode active material 1b (FIG. 5B), a form such that the second solid electrolyte material 3 is disposed so as to coat a surface of the first solid electrolyte material 2 (FIG. 5C), and a form such that the second solid electrolyte material 3 is disposed so as to coat a surface of the anode active material 1b and the first solid electrolyte material 2 (FIG. 5D). Above all, in the present invention, the second solid electrolyte material is preferably disposed so as to coat a surface of the cathode active material or the anode active material. The reason therefor is that the cathode active material or the anode active material is so hard as compared with the first solid electrolyte material that the coated second solid electrolyte material is peeled off with difficulty.

The thickness of the solid electrolyte layer in the present invention is, for example, preferably within a range of 0.1 μm to 1000 μm, and more preferably within a range of 0.1 μm to 300 μm.

4. Other Constitutions

The all solid state battery of the present invention comprises at least the above-mentioned cathode active material layer, anode active material layer and solid electrolyte layer, and ordinarily further comprises a cathode current collector for collecting the cathode active material layer and an anode current collector for collecting the anode active material layer. Examples of a material for the cathode current collector include SUS, aluminum, nickel, iron, titanium and carbon, and preferably SUS among them. On the other hand, examples of a material for the anode current collector include SUS, copper, nickel and carbon, and preferably SUS among them. Also, the thickness and shape of the cathode current collector and the anode current collector are preferably selected properly in accordance with factors such as uses of a lithium solid state battery may be used for a battery case used for the present invention. Examples of the battery case include a battery case made of SUS. Also, with regard to the all solid state battery of the present invention, a power generating element may be formed inside an insulating ring.

5. All Solid State Battery

Examples of kinds of the all solid state battery of the present invention include an all solid lithium battery, an all solid sodium battery; an all solid magnesium battery and an all solid calcium battery and above all, preferably an all solid lithium battery and an all solid sodium battery, and particularly preferably an all solid lithium battery. Also, the all solid state battery of the present invention may be a primary battery or a secondary battery, and preferably a secondary battery among them. The reason therefor is to be repeatedly charged and discharged and be useful as a car-mounted battery, for example. Examples of the shape of the all solid state battery of the present invention include a coin shape, a laminate shape, a cylindrical shape and a rectangular shape.

Also, a producing method for the all solid state battery of the present invention is not particularly limited if the method is a method such as to allow the above-mentioned all solid state battery, but the same method as a producing method for a general all solid state battery may be used. Examples of a producing method for the all solid state battery include a method such that a material composing a cathode active martial layer, a material composing a solid electrolyte layer and a material composing an anode active material layer are sequentially pressed to thereby produce a power generating element and this power generating element is stored inside a battery case, which is crimped.

Incidentally, the present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### EXAMPLES

The present invention is described more specifically while showing examples hereinafter.

### Example 1

(Production of Cathode Body Having Second Solid Electrolyte Material)

First, a cathode active material layer made of LiCoO₂ with a thickness of 200 nm was formed on a Pt substrate by a PVD method. Next, commercially available WO₃ and Li₂CO₃ were mixed so as to be a molar ratio of Li:W=2:1 to produce pellets by pressing. Li₂WO₄ (a second solid electrolyte material) with a thickness of 5 to 20 nm was laminated on the above-mentioned cathode active material layer by a PVD method while regarding these pellets as a target. Thus, a cathode body having the second solid electrolyte material on a surface thereof was obtained.

(Production of All Solid State Battery)

First, Li₇P₃S₁₁ (a first solid electrolyte material) was obtained by the same method as the method described in JP-A No. 2005-228570. Incidentally, Li₇P₃S₁₁ was a sulfide solid electrolyte material having a PS₃—S—PS₃ structure and a PS₄ structure. Next, a power generating element 20 shown in the above-mentioned FIGS. 2A to 2D was produced by using a pressing machine. The above-mentioned cathode body was used as a cathode active material layer 11, an In foil with Li added was used as a material composing an anode active material layer 12, and Li₇P₃S₁₁ was used as a material composing a solid electrolyte layer 13. An all solid state battery was obtained by using this power generating element.

### Comparative Example 1

An all solid state battery was obtained in the same manner as Example 1 except for producing the cathode body having the second solid electrolyte material as described below.

(Production of Cathode Body Having Second Solid Electrolyte Material)

First, a cathode active material layer made of LiCoO₂ with a thickness of 200 nm was formed on a Pt substrate by a PVD method. Next, LiNbO₃ (a second solid electrolyte material) with a thickness of 5 to 20 nm was laminated on the above-mentioned cathode active material layer by a PVD method while regarding a single crystal LiNbO₃ as a target. Thus, a cathode body having the second solid electrolyte material on a surface thereof was obtained.

### Comparative Example 2

An all solid state battery was obtained in the same manner as Example 1 except for producing the cathode body having the second solid electrolyte material as described below.

(Production of Cathode Body Having Second Solid Electrolyte Material)

First, a cathode active material layer made of LiCoO₂ with a thickness of 200 nm was formed on a Pt substrate by a PVD method. Next, commercially available Li₃PO₄ and Li₄SiO₄ were mixed so as to be a molar ratio of 1:1 to produce pellets by pressing. Li₃PO₄—Li₄SiO₄ (a second solid electrolyte material) with a thickness of 5 to 20 nm was laminated on the above-mentioned cathode active material layer by a PVD method while regarding these pellets as a target. Thus, a cathode body having the second solid electrolyte material on a surface thereof was obtained.

[Evaluation]

The interface resistance was measured by using the all solid state battery obtained in each of Example 1, Comparative Examples 1 and 2. First, each of the all solid state battery was charged. The charging was preformed as constant-voltage charge at 3.34 V for 12 hours. After charging, the interface resistance of the cathode active material layer and the solid electrolyte layer was obtained by impedance measurement. The conditions of the impedance measurement were a voltage amplitude of 10 mV, a measuring frequency of 1 MHz to 0.1 Hz, and a temperature of 25° C. Thereafter, the all solid state battery was preserved at a temperature of 60° C. for 8 days, and then the interface resistance of the cathode active material layer and the solid electrolyte layer was obtained similarly. The interface resistance increasing rate was obtained from the interface resistance value after the first charging (the zeroth-day interface resistance value), the fifth-day or sixth-day interface resistance value, and the eighth-day interface resistance value. The result is shown in FIG. 6. Also, the first solid electrolyte material, the second solid electrolyte material, and electronegativity of a skeleton element of each material are shown in Table 1.

TABLE 1

| | First Solid | | Second Solid | |
|---|---|---|---|---|
| | Electrolyte | Electro- | Electrolyte | Electro- |
| | Material | negativity | Material | negativity |
| Example 1 | Li₇P₃S₁₁ | 2.19 (P) | Li₂WO₄ | 2.36 (W) |
| Comparative | Li₇P₃S₁₁ | 2.19 (P) | LiNbO₃ | 1.6 (Nb) |
| Example 1 | | | | |
| Comparative | Li₇P₃S₁₁ | 2.19 (P) | Li₃PO₄—Li₄SiO₄ | 2.19 (P), |
| Example 2 | | | | 1.90 (Si) |

As shown in FIG. 6, the all solid state battery obtained in Example 1 offered a favorable result of the interface resistance increasing rate as compared with the all solid sate battery obtained in each of Comparative Examples 1 and 2. The reason therefor is conceived to be that in Comparative Examples 1 and 2, a difference between electronegativity of Nb element in LiNbO₃ or P element and Si element in Li₃PO₄—Li₄SiO₄ and electronegativity of an oxygen element is larger than or equal to a difference between electronegativity of P element in Li₇P₃S₁₁ and electronegativity of an oxygen element, while in Example 1, a difference between electronegativity of W element in Li₂WO₄ and electronegativity of an oxygen element is so smaller than a difference between electronegativity of P element in Li₇P₃S₁₁ and electronegativity of an oxygen element that oxygen is easily bonded to W element in Li₂WO₄ and the oxidation of Li₇P₃S₁₁ may be restrained.

### REFERENCE SIGNS LIST

1 . . . electrode active material
1a . . . cathode active material
1b . . . anode active material
2 . . . first solid electrolyte material
3 . . . second solid electrolyte material
10 . . . electrode body
11 . . . cathode active material layer
12 . . . anode active material layer
13 . . . solid electrolyte layer
20 . . . power generating element of all solid state battery

1-11. (canceled)

12. An electrode body comprising: an electrode active material comprising an oxide, a first solid electrolyte material comprising a sulfide, and a second solid electrolyte material disposed at an interface between the electrode active material and the first solid electrolyte material,
wherein a difference between electronegativity of a skeleton element in the second solid electrolyte material and electronegativity of an oxygen element is smaller than a difference between electronegativity of a skeleton element bonded to a sulfur element in the first solid electrolyte material and electronegativity of the oxygen element.

13. The electrode body according to claim 12, wherein the skeleton element bonded to the sulfur element in the first solid electrolyte material is at least one kind selected from the group consisting of P, Si, B and Ge.

14. The electrode body according to claim 12, wherein the skeleton element in the second solid electrolyte material is at least one kind selected from the group consisting of W, Au, Pt, Ru and Os.

15. The electrode body according to claim 12, wherein the second solid electrolyte material is disposed so as to coat a surface of the electrode active material.

16. The electrode body according to claim 12, wherein the electrode active material is a cathode active material.

17. An all solid state battery comprising: a cathode active material layer containing a cathode active material, an anode active material layer containing an anode active material, and a solid electrolyte layer formed between the cathode active material layer and the anode active material layer,
wherein at least one electrode active material of the cathode active material and the anode active material comprises an oxide,
a second solid electrolyte material is disposed at an interface between the electrode active material comprising the oxide and a first solid electrolyte material comprising a sulfide, and
a difference between electronegativity of a skeleton element in the second solid electrolyte material and electronegativity of an oxygen element is smaller than a difference between electronegativity of a skeleton element bonded to a sulfur element in the first solid electrolyte material and electronegativity of the oxygen element.

18. The all solid state battery according to claim 17, wherein the cathode active material layer contains the first solid electrolyte material.

19. The all solid state battery according to claim 17, wherein the solid electrolyte layer contains the first solid electrolyte material.

20. The all solid state battery according to claim 17, wherein the second solid electrolyte material is disposed so as to coat a surface of the electrode active material.

21. The all solid state battery according to claim 17, wherein the skeleton element bonded to the sulfur element in the first solid electrolyte material is at least one kind selected from the group consisting of P, Si, B and Ge.

22. The all solid state battery according to claim 17, wherein the skeleton element in the second solid electrolyte material is at least one kind selected from the group consisting of W, Au, Pt, Ru and Os.
